(19) United States
(12) Patent Application Publication
(10) Pub. No.: US 2009/0167473 A1
(43) Pub. Date: Jul. 2, 2009

(54) TRANSFORMER STRUCTURE

(76) Inventor: Wen-Sen Hsieh, Taoyuan Hsien (TW)

Correspondence Address: Joe McKinney Muncy, PO Box 1364, Fairfax, VA, 22038-1364, US

(21) Appl. No.: 11/965,535

(22) Filed: Dec. 27, 2007

(51) Int. Cl. H01F 27/28

(52) U.S. Cl. 336/170

(57) ABSTRACT

The present invention discloses a transformer structure, which has a winding reel. The winding reel has an iron-core frame. A first primary winding, a second primary winding and at least one secondary winding are wound on the iron-core frame. The first primary winding is electrically connected to the second primary winding. The secondary winding is arranged in between the first primary winding and the second primary winding. In the present invention, a plurality of the secondary windings may be arranged in between the first primary winding and the second primary winding and surrounded by the first primary winding and the second primary winding so that the transformer can drive a plurality of loads.

### FIELD OF THE INVENTION

The present invention relates to a transformer structure, particularly to a transformer having a plurality of windings to drive a plurality of loads.

### BACKGROUND OF THE INVENTION

The LCD backlight module needs a long-time stable current. A backlight module comprises a plurality of discharge lamps driven by at least one inverter. The transformer structure of an inverter influences the number of the windings, the output power, and the number of the loads the inverter can drive. A R.O.C. patent No. 1285907 disclosed a “Transformer”. In the conventional transformer, a first winding portion and 2N second winding portions are arranged along an axis, and a pair of iron cores is inserted into an insertion hole of the axis. The 2N second winding portions are respectively arranged at two sides of the first winding portion. A first coil is wound on the first winding portion, and a plurality of second coils is wound on the 2N second winding portions. Thus is formed a structure having a primary winding arranged at the center of a winding reel and a plurality of secondary windings symmetrically arranged at two sides of the primary winding. When several second coils are used, the second coils at two ends of the conventional transformer are far away from the first coil, and the length of the iron cores should increase with the number of the second coils. From the viewpoint of the magnetic path, when the length of the iron cores is too long, or when the distance from the second coils to the first coil is too great, the leakage inductance and power loss will increase. The leakage inductance and power loss of the second coils results in the variation of the induced current. Therefore, the abovementioned conventional transformer, for generating a plurality of outputs, still has room to improve.

### SUMMARY OF THE INVENTION

The primary objective of the present invention is to provide a transformer structure which can generate a plurality of outputs to drive a plurality of loads.

The present invention is a transformer structure, which comprises: a winding reel, an iron-core frame installed on the winding reel, a first primary winding, a second primary winding, and at least one secondary winding, wherein the first primary winding, the second primary winding, and the secondary winding are wound on the iron-core frame, and wherein the first primary winding is electrically coupled to the second primary winding, and wherein the secondary winding is arranged in between the first primary winding and the second primary winding. Besides, more secondary winding can be arranged in between the first primary winding and the second primary winding and surrounded by the first primary winding and the second primary winding so that the transformer can drive a plurality of loads.

### BRIEF DESCRIPTION OF THE DRAWINGS

FIG. 1 is a diagram schematically showing one winding configuration of a transformer structure according to the present invention.

FIG. 2 is a diagram schematically showing another winding configuration of a transformer structure according to the present invention.

FIG. 3 is a diagram schematically showing still another winding configuration of a transformer structure according to the present invention.

FIG. 4 is a perspective view of a first embodiment of the present invention.

FIG. 5 is a bottom view of the first embodiment of the present invention.

FIG. 6 is a bottom view of a second embodiment of the present invention.

FIG. 7 is a perspective view of a third embodiment of the present invention.

### DETAILED DESCRIPTION OF THE PREFERRED EMBODIMENTS

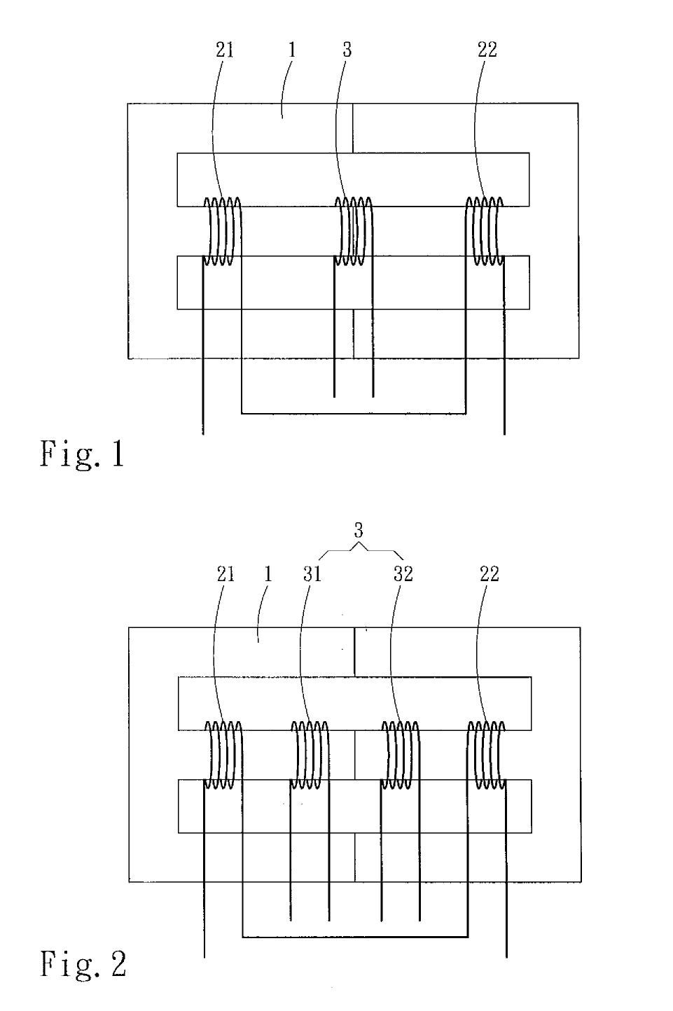

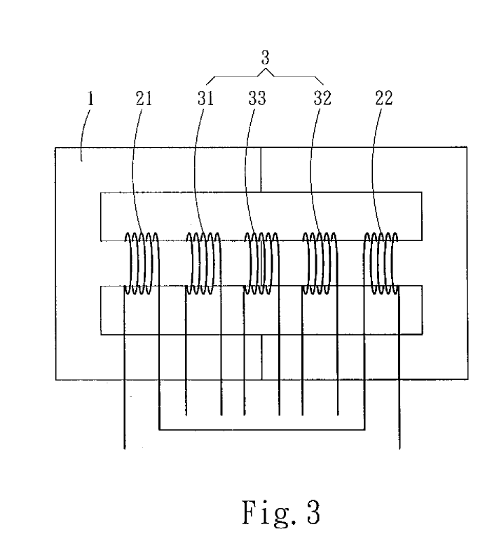

Below, the technical contents of the present invention will be described in detail in cooperation with the drawings. Refer to FIG. 1. The present invention is a transformer structure which has a winding reel. The winding reel has an iron-core frame 1. A first primary winding 21 and a second primary winding 22 are wound on the iron-core frame 1, and the first primary winding 21 is electrically coupled to the second primary winding 22. At least one secondary winding 3 is also wound on the iron-core frame 1 and arranged in between the first primary winding 21 and the second primary winding 22. As shown in FIG. 1, a wire is wound on the iron-core frame 1 to from the first primary winding 21; the identical wire is then pulled out and wound on the iron-core frame 1 to form the second primary winding 22; the first primary winding 21 and the second primary winding 22 are thus electrically coupled via jointly using the identical wire. Another wire is wound on the iron-core frame 1 and in between the first primary winding 21 and the second primary winding 22 to form the secondary winding 3. When the first primary winding 21 and the second primary winding 22 receive a first voltage signal, the secondary winding 3 is induced to have a second voltage signal, which is used to drive at least one load. Refer to FIG. 2 and FIG. 3. A first secondary winding 31 and a second secondary winding 32 are arranged in between the first primary winding 21 and the second primary winding 22. When the first primary winding 21 and the second primary winding 22 receive a first voltage signal, the first secondary winding 31 and the second secondary winding 32 are induced to have a second voltage signal. As shown in FIG. 3, a third secondary winding 33 is further arranged in between the first primary winding 21 and the second primary winding 22. The third secondary winding 33 is induced to have a second voltage signal when the first primary winding 21 and the second primary winding 22 receive a first voltage signal. In addition to the first secondary winding 31, more secondary windings 3 can be arranged in between the first primary winding 21 and the second primary winding 22 according to the driving force of the first primary winding 21 and the second primary winding 22. The secondary windings 3 may respectively have different winding turns, and the secondary windings 3 can be respectively induced to have different second voltage signals to drive different loads.

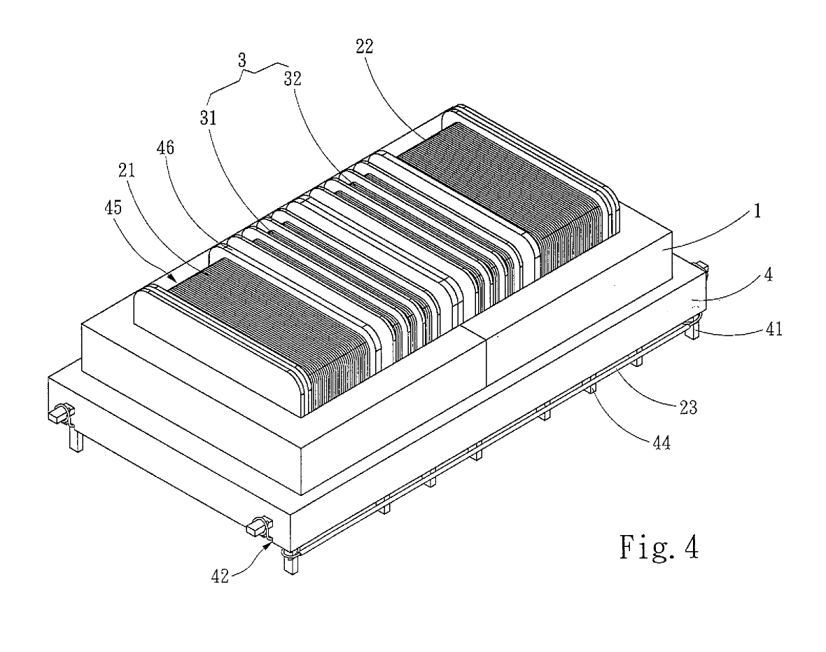

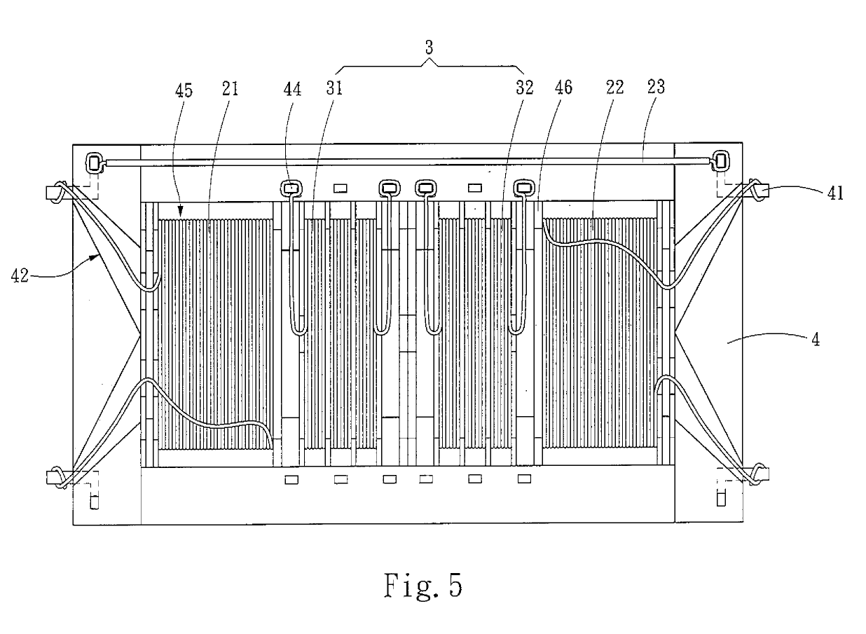

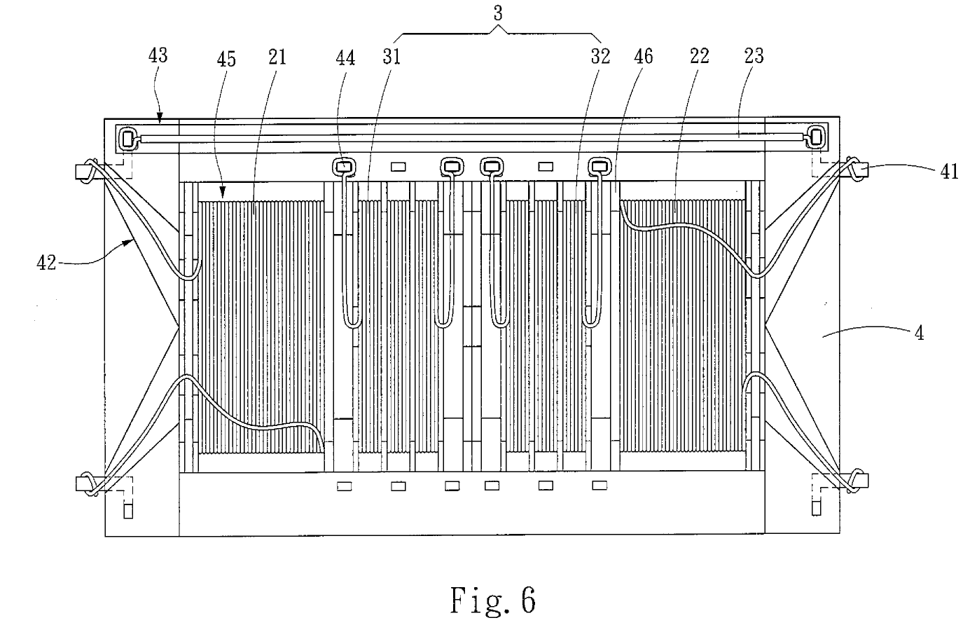

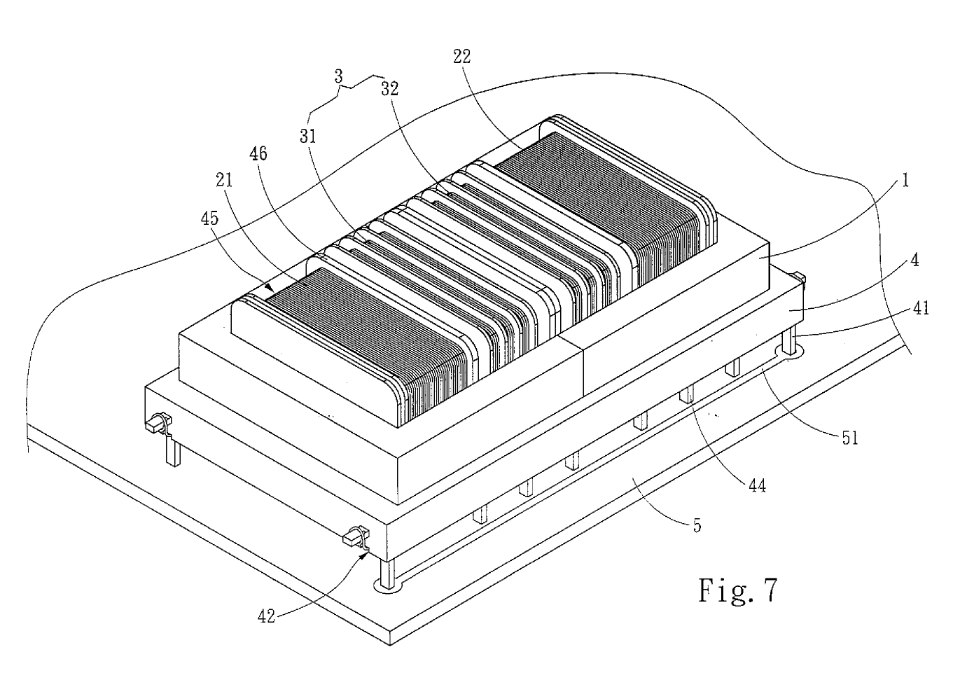

Refer to FIG. 4 and FIG. 5 respectively a perspective view and a bottom view of a first embodiment of the present invention. The transformer structure further comprises a winding reel 4. The iron-core frame 1 is infixed inside the winding reel 4. The winding reel 4 has a plurality of winding grooves 45. In this embodiment, the first primary winding 21, the second primary winding 22, the first secondary winding 31 and the second secondary winding 32 are respectively wound on the winding grooves 45. The winding reel 4 has insulating plates 46. The insulating plates 46 are used to separate the first primary winding 21, the second primary winding 22, the first secondary winding 31 and the second secondary winding 32 and perform an insulating function among them. The winding reel 4 has wire troughs 42 where the wires of the first primary winding 21 and the second primary winding 22 penetrate. The winding reel 4 has lead pins 41 which the leads of the first primary winding 21 and the second primary winding 22 are respectively wound on. A wire 23 is used to connect the lead pins 41 which the leads of the first primary winding 21 and the second primary winding 22 are respectively wound on, whereby the first primary winding 21 and the second primary winding 22 are electrically coupled to form the transformer structure shown in FIG. 2. Besides, the winding reel 4 has electric conduction pins 44 which the wires of the first secondary winding 31 and the second secondary winding 32 are respectively wound on. The first secondary winding 31 and the second secondary winding 32 output power from the electric conduction pins 44. Refer to FIG. 6 a bottom view of a second embodiment of the present invention. The winding reel 4 has a wire slot 43 which the wire 23 passes through to connect the first primary winding 21 and the second primary winding 22. The wire slot 43 is formed via recessing the lower side of the winding reel 4. Alternatively, the wire slot 43 is formed in the injection-molding of the winding reel 4 and embedded inside the winding reel 4. In this embodiment, the first primary winding 21 and second primary winding 22 may use an identical wire. One end of the wire of the first primary winding 21 is led to pass through the wire slot 43 to the other side of the iron-core frame 1, and the wire is then wound to form the second primary winding 22 there. Therefore, the wire slot 43 may facilitate the electric connection of the first primary winding 21 and second primary winding 22.

Refer to FIG. 7 a perspective view of a third embodiment of the present invention. In this embodiment, the transformer structure is mounted on a printed circuit board 5, and the lead pins 41 of the winding reel 4 are electrically connected with the printed circuit board 5. A conductive metal foil 51 is overlaid on or embedded inside the printed circuit board 5 to electrically connect the lead pins 41 which the leads of the first primary winding 21 and the second primary winding 22 are respectively wound on. Thereby, the wire 23 and the wire slot 43 of the preceding embodiment can be omitted.

The present invention has been exemplified with the abovementioned embodiments. However, the embodiments are not intended to limit the scope of the present invention. The abovementioned iron-core frame 1 or winding reel 4 may have various patterns. Although the patterns of the iron-core frame 1 or winding reel 4 is not the focus feature of the present invention, the present invention does not exclude any variation of the iron-core frame 1 or winding reel 4 but includes all the rational variations thereof. Any modification or variation according to the spirit of the present invention is to be also included within the scope of the present invention, which is based on the claims stated below.

According to the above description, the present invention has improvements over the prior art. Thus, the present invention should possess novelty and non-obviousness and meet the requirements for a patent. Therefore, the Inventor files a patent application for the present invention. It will be appreciated if the patent is approved fast.

What is claimed is:

1. A transformer structure having a winding reel with following components arranged thereon:
an iron-core frame infixed inside said winding reel;
a first primary winding and a second primary winding respectively wound in said winding reel, electrically coupled to each other and receiving a first voltage signal; and
at least one secondary winding wound in between said first primary winding and said second primary winding and induced to have a second voltage signal.

2. The transformer structure according to claim 1 further comprising a plurality of secondary windings arranged in between said first primary winding and said second primary winding and respectively induced to have second voltage signals.

3. The transformer structure according to claim 2, wherein said secondary windings respectively have different winding turns.

4. The transformer structure according to claim 2, wherein said secondary windings have an identical winding turn.

5. The transformer structure according to claim 1, wherein said first primary winding and said second primary winding use an identical wire.

6. The transformer structure according to claim 1, wherein said winding reel has a wire slot which one end the wire of said first primary winding passes through to the other side of said winding reel, and the wire is wound on the other side of said winding reel to form said second primary winding.

7. The transformer structure according to claim 1, wherein said winding reel is mounted on a printed circuit board, and said first primary winding and said second primary winding are electrically connected to said printed circuit board.

8. The transformer structure according to claim 7, wherein a conductive metal foil is overlaid on or embedded inside said printed circuit board to electrically connect said first primary winding and said second primary winding.

9. The transformer structure according to claim 1, wherein said first primary winding and said second primary winding are electrically connected with a wire.
